(19) United States
(12) Patent Application Publication
(10) Pub. No.: US 2017/0169213 A1
(43) Pub. Date: Jun. 15, 2017

(54) ELECTRONIC DEVICE AND METHOD FOR RUNNING APPLICATIONS IN DIFFERENT SECURITY ENVIRONMENTS

(71) Applicant: Lenovo (Beijing) Limited, Beijing (CN)

(72) Inventors: Zhiyang Zhao, Beijing (CN); Liangliang Wang, Beijing (CN); Feng Gao, Beijing (CN)

(21) Appl. No.: 15/087,772

(22) Filed: Mar. 31, 2016

(30) Foreign Application Priority Data
Dec. 14, 2015 (CN) 201510923600.X
Dec. 14, 2015 (CN) 201510925145.7

(51) Int. Cl. G06F 21/53; G06F 21/57; G06F 21/62; G06F 21/51; G06F 12/14; H04L 9/32

(52) U.S. Cl. CPC G06F 21/53; G06F 12/1408; H04L 9/3234; G06F 21/629; G06F 21/51; G06F 21/57; G06F 2212/1052; G06F 2221/034; G06F 2221/2149

(57) ABSTRACT

Disclosed is an electronic device, including a processor for running a plurality of applications in different security environments; a display unit for displaying the plurality of applications; an input device that operatively initiates an application to be run by the processor; wherein the processor operatively: detects initiation of the application; determines a security level for running the application; selects a security environment from a plurality of security environments based on the determined security level, the security environments providing different security levels; and runs the application in the selected security environment. Other aspects are described and claimed

### CLAIM FOR PRIORITY

This patent application claims priority to Chinese Application Nos. 201510923600.X and 201510925145.7, each filed on Dec. 14, 2015, the contents of which are fully incorporated herein.

### TECHNICAL FIELD

With the continuous development of science and technology, electronics have also seen rapid advancements, and many electronic devices, such as tablet computers and smartphones, have become necessities in people's daily lives. In order to meet the usage demands of users, electronic devices can often be used to run various operating systems or application programs, thus bringing great flexibility to the electronic devices.

In the prior art, since electronic devices support the operation of various application programs, malicious programs such as Trojans and viruses can enter the electronic device due to the careless operations of a user; such as if a user clicks on a website carrying a virus, the virus can enter and be hosted in the operation system of the electronic device; furthermore, all data, such as important information i.e., telephone contacts, text messages, passwords, pictures, and the like, stored in the operating system of the electronic device can be obtained by the virus.

It is evident that the technical problem of unsafe data storage is present in the prior art.

### BRIEF SUMMARY

In general terms, embodiments of the present application provide an electronic device and a method for running applications in different security environments.

A first aspect is an electronic device, comprising: a processor for running a plurality of applications in different security environments; a display unit for displaying the plurality of applications; an input device that operatively initiates an application to be run by the processor; wherein the processor operatively: detects initiation of the application; determines a security level for running the application; selects a security environment from a plurality of security environments based on the determined security level, the security environments providing different security levels; and runs the application in the selected security environment.

A second aspect is a method, comprising: running a plurality of applications in different security environments on an electronic device; displaying the plurality of applications on the electronic device; initiating an application to be run on the electronic device; determining a security level for running the application; selecting a security environment from a plurality of security environments based on the determined security level, the security environments providing different security levels; and running the application in the selected security environment on the electronic device.

### BRIEF DESCRIPTION OF THE SEVERAL VIEWS OF THE DRAWINGS

Preferred embodiments of the present application will now be described, by way of example only, with reference to the accompanying drawings, of which:

FIG. 1 is a flowchart of a processing method for information security according to a first embodiment;

FIG. 2 is an exemplary schematic diagram of a processing device for information security according to a second embodiment;

FIG. 3 is an exemplary schematic diagram of a first security mechanism under a first security environment;

FIG. 4 is an exemplary schematic diagram that additionally shows a second security mechanism under a second security environment;

FIG. 5 is a flowchart of a data safety storage method according to another embodiment;

FIG. 6 is a flowchart of a specific implementation manner of step S101 of FIG. 5;

FIG. 7 is a flowchart of a specific implementation manner of step S102 of FIG. 5;

FIG. 8 is a flowchart of the steps executed after step S103 of FIG. 5;

FIG. 9 is a flowchart of executing the reading data in another embodiment; and

FIG. 10 is a schematic diagram of an electronic device of an embodiment of the present application.

### DETAILED DESCRIPTION

In the following embodiments, an electronic equipment refers to an equipment that is able to communicate with other equipment. The specific forms of the electronic equipment include but are not limited to: mobile phone, personal computer, digital camera, personal digital assistant, portable computer, game console and the like. The electronic equipment is provided with a first execution environment and a second execution environment, wherein the first execution environment may be the operating system used in mobile terminals (e.g., Android, IOS etc., with powerful processing capacity and multimedia function) or part of the operating system that can implement part of the functions of the operating system. The first execution environment, for example, may be a general execution environment, i.e. REE (Rich Execution Environment); the second execution environment is a trusted execution environment with secure processing capacity and providing secure peripheral operations, e.g., TEE (Trusted Execution Environment). The second execution environment is isolated from the first execution environment described above and running independently, although they are on the same electronic equipment. In addition, the second execution environment may be a trusted operating system, the only function of which is to run and provide a trusted execution environment, therefore, the second execution environment has higher security than the first execution environment.

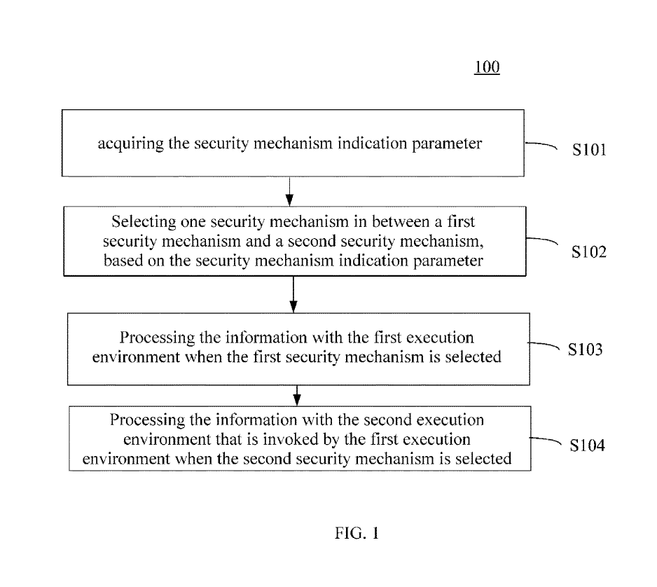

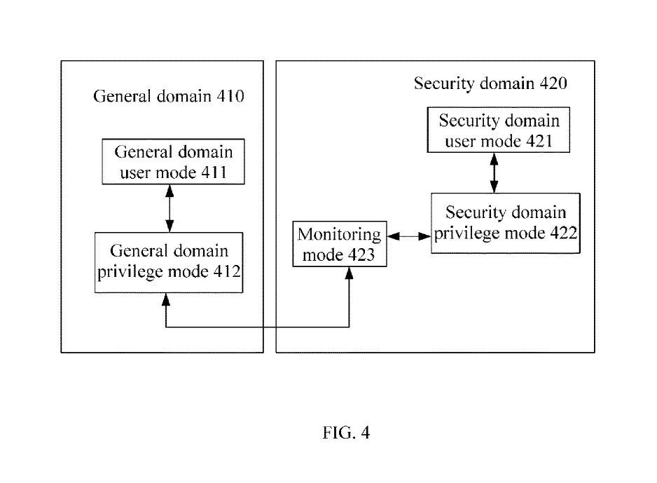

FIG. 1 depicts a flowchart of a processing method 100 for information security according to an embodiment. FIG. 3 is an exemplary schematic diagram of a first security mechanism; FIG. 4 is an exemplary schematic diagram of a second security mechanism. The processing method 100 for information security can be applied to the electronic equipment described above, which can be configured to securely process the information.

As seen in FIG. 1, in Step S101, an security mechanism indication parameter is acquired. The security mechanism indication parameter is used to indicate the corresponding security mechanism for handling a predetermined event. According to one embodiment, there exist a plurality of security mechanism, for example, at least two security mechanisms. Different security mechanisms correspond to different security levels, for example, the second security mechanism may be set to have higher security than the first security mechanism. Said predetermined event described above may be triggered by an application program interface, the status of current running environment. For example, the activation of an application program or thread, and the running environments of different application programs or threads require different security mechanisms for data processing. Alternatively, the predetermined event may also be triggered by events such as the status of operating system, user input actions, etc.

In Step S102, one security mechanism is selected between the first security mechanism and the second security mechanism, based on the acquired security mechanism indication parameter. According to an embodiment, the first security mechanism is selected when it is determined to use the first security mechanism to handle the current event, based on the security mechanism indication parameter; the second security mechanism is selected when it is determined to use the second security mechanism to handle the current event, based on the security mechanism indication parameter. For example, on the electronic equipment may be installed a first application and a second application, and the running environments of the first application and the second application require different security levels, therefore, the security mechanism indication parameter for the first application and the second application are different; the first security mechanism is selected when it is determined to use the first security mechanism to handle the first application, based on the security mechanism indication parameter; the second security mechanism is selected when it is determined to use the second security mechanism to handle the second application, based on the security mechanism indication parameter.

The first application, for example, may be an application for unlocking the screen, the second application, for example, may be an application for financial payment. Since the application for unlocking the screen does not require more security and confidentiality measures, and users often expect that the program can run fast to save time, the security mechanism indication parameter for the first application may rely on the first security mechanism to process the information of that application. In contrast, the financial payment involves users' money transactions, so it requires enhanced protection for users' payment information to prevent attacks from hackers, therefore, the security mechanism indication parameter for the second application may use the second security mechanism to process the information. As a result, when the first application is initiated via an input device (e.g a touch screen or a computer mouse that controls a computer cursor) of the electronic equipment, the processor operatively detects said initiation and selects a security environment from a plurality of security environments providing different security levels. Specifically, the processor determines a security level for running the first application based on the security mechanism indication parameter for the first application, the system then determines the use of the first security mechanism which provides an appropriate security environment to process data, and process the data of the first application. Similarly, when the second application is activated, based on the security mechanism indication parameter for the second application, the system determines to use the second security mechanism to process data, then the second security mechanism is selected to process the data of the second application.

In Step S103, the information is processed with the first execution environment when the first security mechanism is selected. According an embodiment, in the first security mechanism, the information can be processed securely with the aforementioned first execution environment alone. The first execution environment can be the general execution environment discussed earlier, i.e. REE (Rich Execution Environment). First, the security information input by the user via the input device into the electronic equipment is received with the first execution environment, then it is determined whether the security information matches the relevant information registered in advance, and the determination is fed back to the first execution environment when there is a match. For example, when the application for unlocking the screen is running, it can receive the fingerprint, gesture or password input by a user via the Android operating system alone, and determine whether the input matches, and the determination is directly fed back to the Android operating system when there is a match, and the validation succeeds.

FIG. 3 is an exemplary architectural diagram of the first security mechanism. As seen in FIG. 3, according to one example, the first security mechanism may comprise a general domain 300 comprising a general domain user mode 310, a general domain privilege mode 320. The general domain user mode 310 is in communication with the general domain privilege mode 320, and information communication can be achieved between them. After a user has input the security information, the security information input by the user can be received via the general domain user mode 310, and then the security information input by the user is validated via the general domain privilege mode 320 to ensure the security during the validation. According to an embodiment, the general domain 300 described above is configured in the first execution environment. Under the first security mechanism, there is no need to implement additional security protection and security measures for the security information input by the user, therefore it has effectively accelerated the process of the security information and increased the operational efficiency of the application program.

In Step S104, the information is processed with the second execution environment that is invoked by the first execution environment when the second security mechanism is selected. According to one embodiment, in the second security mechanism, the information can be processed with the second execution environment that is invoked by the first execution environment. After it is determined in Step S102 based on the security mechanism indication parameter that a certain program selects the second security mechanism, for example, after the activation of a certain application program in the first execution environment that requires the second security mechanism for data processing, in Step S104, first, the second execution environment is invoked via the first execution environment; then the security information input by the user is received with the second execution environment, and it is determined whether the security information matches the relevant information registered in advance; and the determination is fed back to the second execution environment when there is a match. For example, after a certain program for financial payment in the Android system is activated, or when that program is prompting the user to enter the payment password, the Android system will invoke the trusted execution environment, TEE, and receive the payment password entered by the user via the trusted execution environment, and determine whether the password is correct, and feed back to the trusted execution environment when it's correct, whereby the validation succeeds.

FIG. 4 is an exemplary schematic diagram of the second security mechanism. As seen in FIG. 4, according to one example, the second security mechanism may comprise a general domain 410 and a security domain 420. Wherein, the general domain 410 may comprise a general domain user mode 411, a general domain privilege mode 412. The general domain user mode 411 is in communication with the general domain privilege mode 412, and information communication can be achieved between them. The security domain 420 comprises a security domain user mode 421, a security domain privilege mode 422, a monitoring mode 423; the security domain user mode 421 is in communication with the security domain privilege mode 422, and achieves information interaction with the security domain privilege mode 422; the security domain privilege mode 422 is in communication with the monitoring mode 423 and achieves information interaction with the monitoring mode 423. In addition, the general domain 410 communicates with the security domain 420 via the monitoring mode 423 in the security domain 420.

According to one example, the general domain 410 may be configured in the first execution environment, and the security domain 420 may be configured in the second execution environment. The first execution environment achieves information interaction with the second execution environment via the monitoring mode 423.

After the second security mechanism has been activated and the first execution environment has invoked the second execution environment, the security information input by the user is received via the security domain user mode 421. In addition, the security domain 420 may also comprise a secure memory, in which the security information input by the user can be stored.

In the embodiment, the first security mechanism or the second security mechanism is selected based on the security mechanism indication parameter, and the information is processed based on the corresponding security mechanism, for example, when the user is playing games on an electronic equipment, unlocking the electronic equipment meant that the first security mechanism ought to be selected to meet the user's need for speed, while guaranteeing the security. When the user needs to make an electronic payment, the second security mechanism is selected, and the trusted execution environment is invoked to process the information, which provides an effective secure protection to the storage and transmission of the security information, guaranteeing the security of information processing.

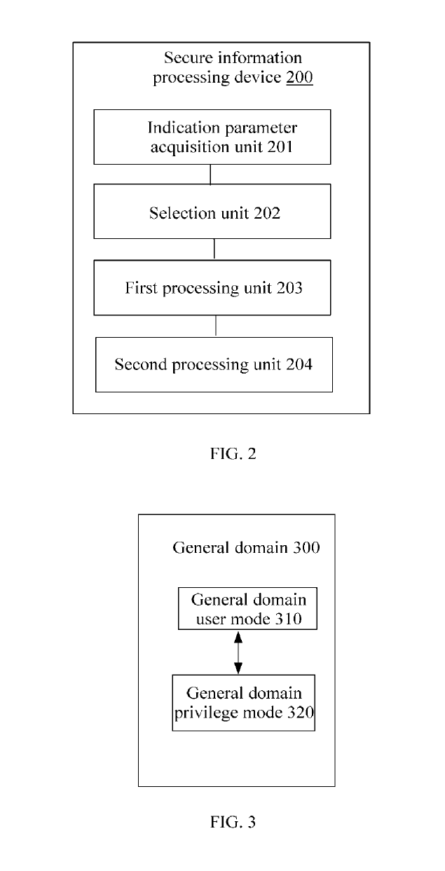

FIG. 2 depicts an exemplary frame diagram of a processing device 200 for information security according to an second embodiment. The processing device 200 for information security can be applied to the electronic equipment described above, which can be configured to securely process the information. The processing device 200 for information security corresponds to the processing method 100 for information security; it will be briefly described below for brevity of the description.

As seen in FIG. 2, the processing device 200 for information security comprises: an indication parameter acquisition unit 201, a selection unit 202, a first processing unit 203 and a second processing unit 204.

The indication parameter acquisition unit 201 is to acquire security mechanism indication parameter. The security mechanism indication parameter is used to indicate the corresponding security mechanism for handling a predetermined event. According to an embodiment, there exist a plurality of security mechanisms, for example, at least two security mechanisms. Different security mechanisms correspond to different security levels, for example, the second security mechanism may be set to have higher security than the first security mechanism. The predetermined event described above may be triggered by an application program interface, the status of current running environment. For example, the activation of an application program or thread, and the running environments of different application programs or threads require different security mechanisms for data processing. Alternatively, the predetermined event may also be triggered by events such as the status of operating system, user input actions, etc.

The selection unit 202 is to select one security mechanism between the first security mechanism and the second security mechanism, based on the security mechanism indication parameter. According to an embodiment, the first security mechanism is selected when it is determined to use the first security mechanism to handle the current event, based on the security mechanism indication parameter; the second security mechanism is selected when it is determined to use the second security mechanism to handle the current event, based on the security mechanism indication parameter. For example, on the electronic equipment may be installed a first application and a second application, and the running environments of the first application and the second application require different security levels, therefore, the security mechanism indication parameter for the first application and the second application are different, the first security mechanism is selected when it is determined to use the first security mechanism to handle the first application, based on the security mechanism indication parameter; the second security mechanism is selected when it is determined to use the second security mechanism to handle the second application, based on the security mechanism indication parameter.

The information is processed by the first processing unit 203 with the first execution environment when the first security mechanism is selected. According to an embodiment, in the first security mechanism, the information can be securely processed with the aforementioned first execution environment alone. The first execution environment can be the general execution environment discussed earlier, i.e. REE (Rich Execution Environment). First, the security information input by the user is received with the first execution environment, then it is determined whether the security information matches the relevant information registered in advance, and the determination is fed back to the first execution environment when there is a match. For example, when the application for unlocking the screen is running, the fingerprint, gesture or password input by a user can be received via the Android operating system alone, and it is determined whether the input matches, and the determination is directly fed back to the Android operating system when there is a match, and the validation succeeds.

The information is processed by the second processing unit 204 with the second execution environment that is invoked by the first execution environment when the second security mechanism is selected. According to an embodiment, in the second security mechanism, the information can be processed with the second execution environment that is invoked by the first execution environment. After the selection unit 202 has determined based on the security mechanism indication parameter that a certain program selects the second security mechanism, e.g., after the activation of a certain application program in the first execution environment that requires the second security mechanism for data processing, the second processing unit 204 first invokes the second execution environment via the first execution environment; then receives the security information input by the user with the second execution environment, determines whether the security information matches the relevant information registered in advance; and feeds back to the second execution environment when there is a match. For example, after a certain program for financial payment in the Android system is activated, or when that program is prompting the user to enter the payment password, the Android system will invoke the trusted execution environment, TEE, and receive the payment password entered by the user via the trusted execution environment, and determine whether the password is correct, and feed back to the trusted execution environment when it's correct, whereby the validation succeeds.

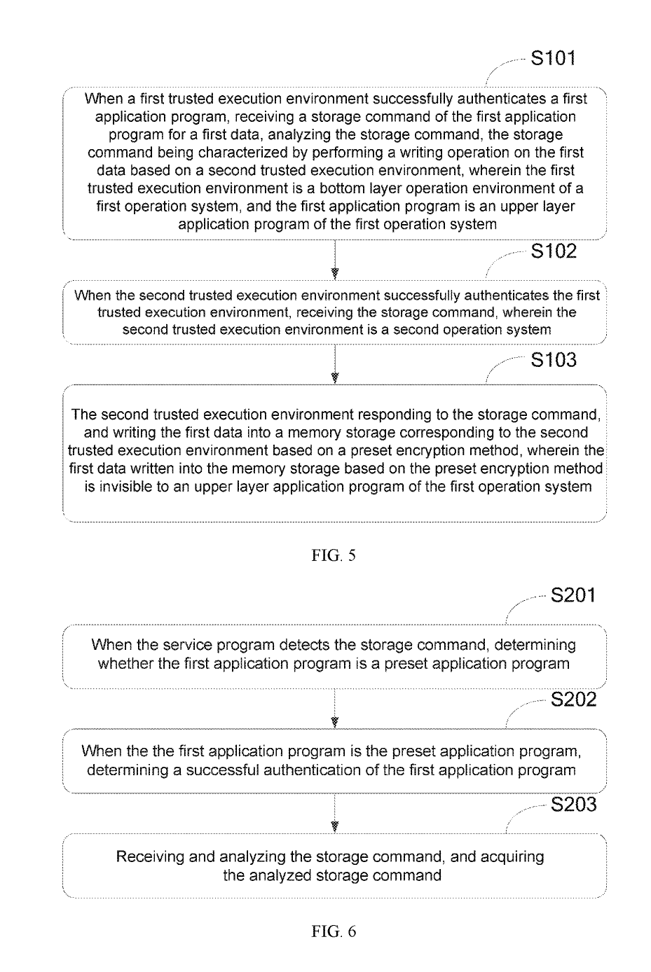

FIG. 5 shows a flow diagram of a data safety storage method according to a further embodiment, the method comprising:

S101: in response to a first trusted execution environment successfully authenticating a first application program, receiving a storage command of the first application program for a first data, analyzing the storage command, the storage command being characterized by performing a writing operation on the first data based on a second trusted execution environment, wherein the first trusted execution environment is a bottom layer operation environment of a first operation system, and the first application program is an upper layer application program of the first operation system;

S102: in response to a second trusted execution environment successfully authenticating the first trusted execution environment, receiving the storage command, wherein the second trusted execution environment is a second operation system;

S103: the second trusted execution environment responding to the storage command, and writing the first data into a memory storage corresponding to the second trusted execution environment based on a preset encryption method, wherein the first data written into the memory storage based on the preset encryption method is invisible to an upper layer application program of the first operation system.

In the specific process of embodiment, the data safety storage method can be specifically applied to a smartphone, a tablet computer, or a laptop, and of course other smart terminals which are not enumerated herein.

In a smart terminal, by separating the hardware and software resources of an on-chip system in the terminal, two operation environments, namely a first trusted execution environment and a second trusted execution environment, exist in the smart terminal which can be switched in the two operation environments. In an embodiment, the first trusted execution environment is a Rich Execution Environment (REE) of the smart terminal, and can be used for operating various wide and universal operation systems, thus allowing the operation of various application programs in the REE; the second trusted execution environment is a Trusted Execution Environment (TEE) of the smart terminal, coexisting with the REE, is specially used for providing a safety region for the smart terminal to executing trusted code and making all code executed in the TEE highly reliable, so that usage and storage processing of important data resources in the smart terminal are all performed in the TEE.

Before step S101 of FIG. 5, the method may further comprise:

establishing a first service program in the first trusted execution environment;

establishing a safety application in the second trusted execution environment.

In a specific implementation process, by taking the application of the data safety storage method to a smartphone, the first trusted execution environment being a REE and the second trusted execution environment is a TEE as an example, before data storage, a service program (CA) for storage is required to be created in the REE end of the smartphone and is called CA1; and a safety application (TA) is created at the TEE end, and named TA1. Meanwhile, CA1 is set to only process a command request of an authorized application program, such as the authorized application program of CA1 is set to be the singly developed application program aiming at a request of data safety, or a QQ application program or WeChat application program; TA1 is set to be called only by specific CAs: such as TA1 is set to be called only by CA1.

As shown in FIG. 6, a specific implementation method of step S101 of FIG. 5 may comprise:

S201: in response to the service program detecting the storage command, determining whether the first application program is a preset application program;

S202: in response to detecting that the first application program is the preset application program, determining the successful authentication of the first application program;

S203: receiving and analyzing the storage command, and acquiring the analyzed storage command.

In a specific implementation process, by using the above example, when a QQ application program in the smartphone operates on an Android system of the smartphone, based on a selecting operation of the user in a display interface of the QQ application program via a display unit of the electronic device, a storage device for storing a chat record into the smartphone is generated; then, the QQ application program calls CA1 in the REE, after CA1 detects the command of storing the chat record of the QQ application program, firstly, the QQ application program is subjected to authentication, such as verification by an RSA-2048 public key or signature, which is not limited in an embodiment. By taking the signature verification as an example, at this time, CA1 acquires the signature of the QQ application program and compares with that of a preset application program, if the signature of the QQ application program is same as that of the preset application program, then the QQ application program is judged as an authorized application program and authentication is successful. Then, CA1 analyzes the acquired storage command; the analyzed command content is the storage data; and the storage data is the chat record.

After step S101 of FIG. 5 is executed and before the step 102 is executed, the method further comprises:

encrypting the analyzed storage command analyzed based on a first encryption method, and acquiring the encrypted storage command; and

sending the encrypted storage command to the safety application based on a secured communicative channel.

In a specific implementation process, by using the above example, after CA1 acquires the analyzed storage command, the analyzed storage command is encrypted, for example the analyzed command content and data content are subjected to RSA-2048 public key encryption, of course, those skilled in the art can adopt other encryption methods, which is not limited in an embodiment. After the encryption is finished, CA1 sends the encrypted command to the corresponding safety application in the TEE, since the command received by CA1 is the command data storage, CA1 determines TA1 is to be initiated for activation, thus sending the encrypted command to TA1 by the secured communicative channel of the REE and TEE, wherein the secured communicative channel is a communication channel in a hardware level created between the REE and the TEE in the smartphone, so as to ensure the communication safety of the REE end and the TEE end.

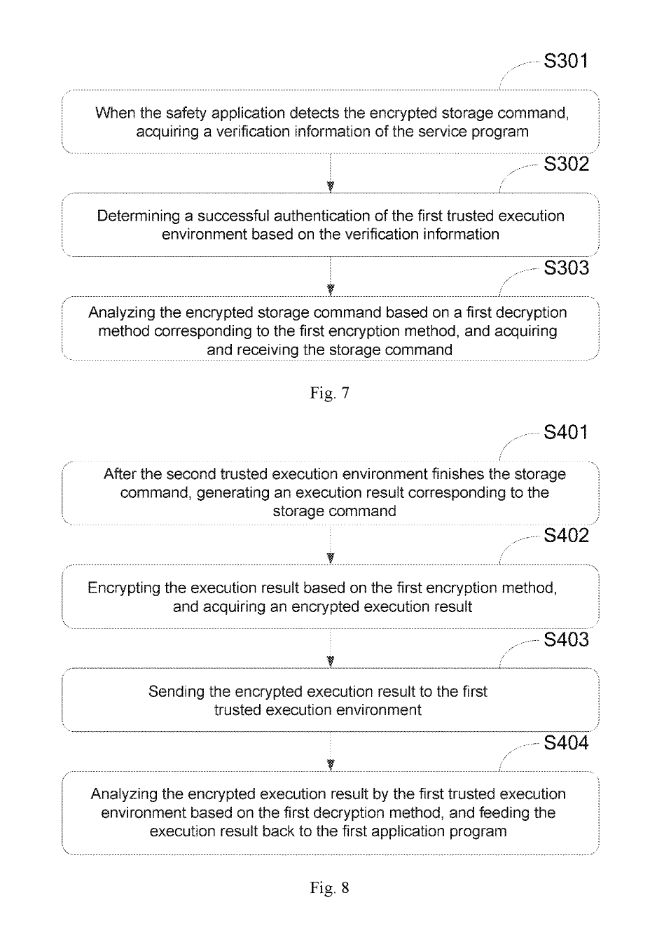

FIG. 7 shows a specific implementation manner of step S102 of FIG. 5, as follows:

S301: in response to the safety application detecting the encrypted storage command, acquiring the verification information of the service program;

S302: determining a successful authentication of the first trusted execution environment based on the verification information;

S303: analyzing the encrypted storage command based on a first decryption method corresponding to the first encryption method, and acquiring and receiving the storage command.

In a specific implementation process, continuing with the above example, after CA1 sends the encryption command to TA1, the smart terminal loads an operation system corresponding to the TEE, thus operating the TEE. TA1 receives the calling information sent from CA1, then performs permissible verification on CA1, such as by verifying CA ID and Challenge whether CA1 is permissible; of course, those skilled in the art can adopt other verification methods. By taking CA ID as an example, TA1 firstly acquires an ID number, such as 1, of CA1, compares with a preset ID number in TA1, and judges whether the ID number matches with the present ID number. If so, the authentication is successful. TA1 subsequently acquires the encrypted command that is sent from CA1, and decrypts the encrypted command, in a specific implementation process, such as RSA-2048, preset for the TA and CA. Of course, those skilled in the art can adopt other encryption and decryption methods. The TA decrypts the encrypted command sent from CA1 by adopting a RSA-2048 private key, thus acquiring an original command sent by the QQ application program; and the acquired data content in the form of the chat record is stored.

In a specific implementation process, by following the above example, after TA1 acquires the storage command for storing the chat record, TA1 encrypts the acquired data to be stored and stores in a corresponding storage unit of the TEE. For example, the chat record of the QQ application program is encrypted in a DES encryption method, thus finishing the safe storage of the QQ chat record. As the data stored in the TEE end is invisible to other application programs in the smartphone, such as WeChat and text messaging, information security is ensured. Of course, it should be appreciated that other encryption methods could also be used.

FIG. 8 shows that after step S103 is executed, the method may further comprise:

S401: in response to the second trusted execution environment finishing the storage command, generating an execution result corresponding to the storage command;

S402: encrypting the execution result based on the first encryption method, and acquiring an encrypted execution result;

S403: sending the encrypted execution result to the first trusted execution environment;

S404: analyzing the encrypted execution result by the first trusted execution environment based on the first decryption method, and feeding the execution result back to the first application program.

In a specific implementation process, after TA1 stores the encrypted chat record on the corresponding storage at the TEE end, TA1 generates an execution result, such as a storage address of 1005, then encrypts the execution result by adopting an RSA-2048 public key, and sends the encrypted execution result to CA1 by the secured communicative channel, after CA1 receives the encrypted execution result, CA1 decrypts by adopting an RSA-2048 private key, acquires the execution result that the a storage address is 1005 and feeds back to the QQ application program.

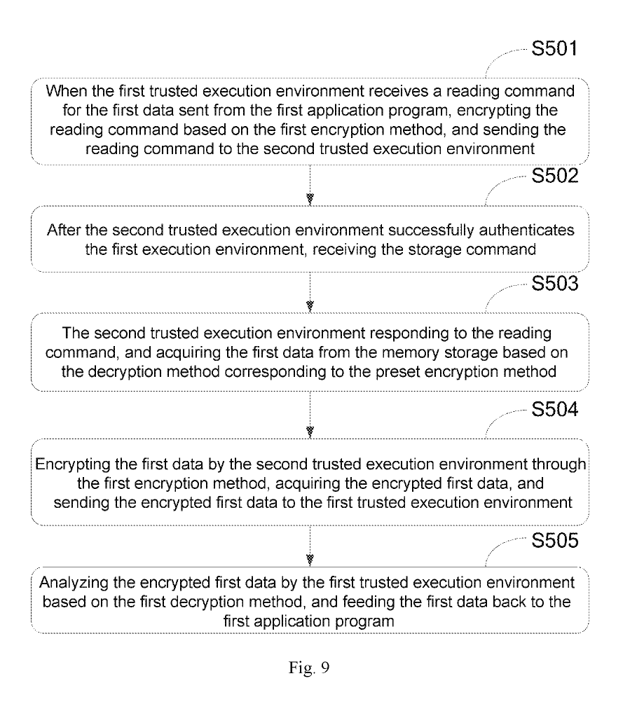

FIG. 9 shows that after the feeding back of the execution result is executed, the method may further comprise a process of data reading, as follows:

S501: in response to the first trusted execution environment receiving a reading command for the first data sent from the first application program, encrypting the reading command based on the first encryption method, and sending the reading command to the second trusted execution environment;

S502: after the second trusted execution environment successfully authenticates the first execution environment, receiving the storage command;

S503: the second trusted execution environment responding to the reading command, and acquiring the first data from the memory storage based on the decryption method corresponding to the preset encryption method;

S504: acquiring the first data, encrypting the first data by the second trusted execution environment through the first encryption method, and sending the encrypted first data to the first trusted execution environment;

S505: analyzing the encrypted first data by the first trusted execution environment based on the first decryption method, and feeding the first data back to the first application program.

In a specific implementation process, by following the above example, when the smartphone finishes the safe storage of the QQ chat record, the smartphone receives a data reading command for acquiring the chat record sent from the QQ application program, whereupon the REE end will call a service program corresponding to the reading command, naming it CA2, and set the authorized application program capable of being processed by CA2 as the QQ application program; CA2 then authenticates the AA application program, the specific authentication method being the same as in step S101 of FIG. 5, and when CA2 judges that the QQ application program is the authorized application program, successful authentication is realized. CA2 then analyzes the acquired reading command, encrypts the analyzed reading command, and then sends it to TA2 by the secured communicative channel corresponding to the TEE at the TEE end (the safety application preset at the TEE end for data reading); TA2 firstly verifies whether CA2 is permissible, a specific verifying method is as shown in step S102 of FIG. 5, and after CA2 is judged to be permissible, TA2 acquires the encryption command sent from CA2, decrypts the encryption command and acquires the command for reading the chat record of the QQ application program, so that the chat record is acquired from the corresponding storage unit in the TEE, is encrypted and then sent to CA2 by the secured communicative channel. After CA2 decrypts the encrypted information, CA2 acquires the chat record, and feeds it back to the QQ application program, thus finishing the data reading.

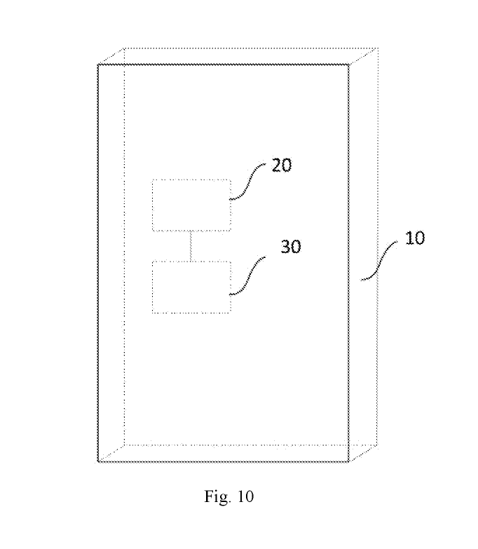

FIG. 10 shows a schematic drawing of an electronic according to another embodiment, comprising:

a housing 10;

a storage device 20, arranged in the housing 10, wherein the storage device comprises a first memory storage and a second memory storage, the first memory storage is used for storing first system files corresponding to the first operation system and application program files corresponding to the first application program, and the second memory storage is used for storing second system files corresponding to the second operation system;

a processor 30, arranged in the housing 10, and in response to a first trusted execution environment successfully authenticating a first application program, receiving a storage command of the first application program for a first data, analyzing the storage command, the storage command being characterized by performing a writing operation on the first data based on a second trusted execution environment, wherein the first trusted execution environment is a bottom layer operation environment of a first operation system, and the first application program is an upper layer application program of the first operation system. In response to a second trusted execution environment successfully authenticating the first trusted execution environment, receiving the storage command, wherein the second trusted execution environment is a second operation system; responding to the storage command by the second trusted execution environment, and writing the first data into a memory storage corresponding to the second trusted execution environment based on a preset encryption method, wherein the first data written into the memory storage based on the preset encryption method is invisible to an upper layer application program of the first operation system.

One of ordinary skill in the art may be aware that the units and algorithm steps in each example described with reference to the embodiments disclosed herein can be implemented by electronic hardware, computer software or the combination of both. And the software module may be installed in a computer storage medium of any form. To clearly illustrate the interchangeability between the hardware and the software, the composition and steps of each example has been generally described in the above description in light of functions. Whether these functions will be carried out by hardware or software depends on specific applications and design constrains of the technical solution. For each specific application, a skilled artisan in the art may implement the described function by different means, but it should not be considered as beyond the scope of the present disclosure.

A person skilled in the art should understand that various modifications, combinations, partial combinations, and substitutions can be carried out depending on design requirements and other factors, as long as they are within the scope of the appended claims and the equivalents thereof.

What is claimed is:

1. An electronic device, comprising:
a processor for running a plurality of applications in different security environments;
a display unit for displaying the plurality of applications;
an input device that operatively initiates an application to be run by the processor;
wherein the processor operatively:
detects initiation of the application;
determines a security level for running the application;
selects a security environment from a plurality of security environments based on the determined security level, the security environments providing different security levels; and
runs the application in the selected security environment.

2. The electronic device of claim 1, wherein the processor is operable to acquire a security environment indication parameter in relation to the initiated application and the selected security environment is based on the acquired security environment indication parameter.

3. The electronic device of claim 1, wherein in a first security environment, the processor operatively:
receives user security information from the input device;
determines whether the received user security information matches with authorized user security information; and
verifies a user identity if there is a match.

4. The electronic device of claim 1, wherein whilst the application is running in a first security environment, the processor operatively invokes a second security environment that provides a higher security level than that of the first security environment.

5. The electronic device of claim 4, wherein in the first security environment, the processor operatively:
receives user security information via the input device;
determine whether the received user security information matches with authorized user security information; and
verifies a user identity if there is a match.

6. The electronic device of claim 5, further comprising a secure memory, wherein in response to verifying the user identity, the processor operatively:
receives a write command;
encrypts data corresponding to the write command; and
writes the encrypted data to the secure memory.

7. The electronic device of claim 6, wherein in response to verifying the user identity, the processor further operatively:
retrieves the encrypted data from the secure memory;
decrypts the encrypted data; and
displays the decrypted data.

8. The electronic device of claim 4, wherein the first security environment is a rich execution environment (REE) and the second security environment is a trusted execution environment (TEE).

9. A method, comprising:
running a plurality of applications in different security environments on an electronic device;
displaying the plurality of applications on the electronic device;
initiating an application to be run on the electronic device;
determining a security level for running the application;
selecting a security environment from a plurality of security environments based on the determined security level, the security environments providing different security levels; and
running the application in the selected security environment on the electronic device.

10. The method of claim 9, wherein the selecting the security environment comprises acquiring a security environment indication parameter in relation to the initiated application and selecting the security environment based on the acquired security environment indication parameter.

11. The method of claim 9, running the application in a first security environment on the electronic device comprises:
receiving user security information;
determining whether the received user security information matches with authorized user security information; and
verifying a user identity if there is a match.

12. The method of claim 9, further comprising invoking a second security environment that provides a higher security level than that of a first security environment, whilst running the application in the first security environment on the electronic device.

13. The method of claim 12, wherein the running the application in the first security environment on the electronic device comprises:
receiving user security information;
determining whether the received user security information matches with authorized user security information; and
verifying a user identity if there is a match.

14. The method of claim 13, wherein in response to verifying the user identity, the method further comprises:
receiving a write command;
encrypting data of the electronic device corresponding to the write command; and
writing the encrypted data to a secure memory.

15. The method of claim 14, wherein in response to verifying the user identity, the method further comprises:
retrieving the encrypted data from the secure memory;
decrypting the encrypted data; and
displaying the decrypted data from the electronic device.

16. The method of claim 12, wherein the first security environment is a rich execution environment (REE) and the second security environment is a trusted execution environment (TEE).
